(19) United States
(12) Patent Application Publication
(10) Pub. No.: US 2026/0088322 A1
(43) Pub. Date: Mar. 26, 2026

(54) FUEL CELL STACK

(71) Applicant: TOYOTA JIDOSHA KABUSHIKI KAISHA, Toyota-shi (JP)

(72) Inventors: Nobuaki NONOYAMA, Chiryu-shi (JP); Yasushi TAKAHASHI, Mishima-shi (JP)

(73) Assignee: TOYOTA JIDOSHA KABUSHIKI KAISHA, Toyota-shi (JP)

(21) Appl. No.: 19/190,914

(22) Filed: Apr. 28, 2025

(30) Foreign Application Priority Data
Sep. 24, 2024 (JP) 2024-165361

(51) Int. Cl. H01M 8/2483; H01M 8/0247

(52) U.S. Cl. CPC H01M 8/2483; H01M 8/0247

(57) ABSTRACT

Fuel cells each includes: a frame body made of resin and including an opening portion; a membrane electrode assembly disposed at the opening portion; and first and second separators facing each other through the frame body and the membrane electrode assembly. A first manifold hole is provided in a fuel cell stack. The frame body includes a frame-body inner edge demarcating the first manifold hole. The first separator includes a first-separator inner edge demarcating the first manifold hole, a flat portion disposed along the first-separator inner edge, a concave-convex portion forming gas passages, and a border line between the flat portion and the concave-convex portion. When a specific line is defined as a line that is away from the border line toward the first-separator inner edge, the frame-body inner edge is positioned at a side that is more distant from the first manifold hole than the specific line is.

### CROSS-REFERENCE TO RELATED APPLICATION

This application claims priority to Japanese Patent Application No. 2024-165361 filed on Sep. 24, 2024. The disclosure of the above-identified application, including the specification, drawings, and claims, is incorporated by reference herein in its entirety.

### BACKGROUND

### 1. Technical Field

A technology disclosed in the present specification relates to a fuel cell stack.

### 2. Description of Related Art

Japanese Unexamined Patent Application Publication No. 2010-27381 (JP 2010-27381 A) discloses a fuel cell stack. The fuel cell stack has a structure in which a membrane electrode assembly is enclosed by a frame body made of resin. Further, the fuel cell stack has a structure in which the membrane electrode assembly is sandwiched between a separator for a cathode and a separator for an anode, together with the frame body. A manifold hole of the frame body and manifold holes of both separators are laminated, and thereby, a manifold hole that extends in a lamination direction is formed. A plurality of gas passages that extends toward the membrane electrode assembly is disposed on an inner circumferential surface of the manifold hole.

### SUMMARY

A water droplet remaining on the inner circumferential surface of the manifold hole wetly spreads so as to cover all gas passages, in some cases. When the water droplet having wetly spread freezes and blocks all gas passages, the supply and exhaust of a rection gas cannot be performed for the membrane electrode assembly at the time of start, so that electricity generation cannot be performed, in some cases.

A fuel cell stack disclosed in the present specification is a fuel cell stack in which a plurality of fuel cells is laminated. Each of the fuel cells includes: a frame body that is made of resin and that includes an opening portion; a membrane electrode assembly that is disposed at the opening portion; and a first separator and a second separator that face each other through the frame body and the membrane electrode assembly. A first manifold hole that extends along a lamination direction is provided in the fuel cell stack. The frame body includes a frame-body inner edge that demarcates the first manifold hole. The first separator includes a first-separator inner edge that demarcates the first manifold hole, a flat portion that is disposed along the first-separator inner edge and that is disposed on a facing surface that faces the second separator, a concave-convex portion that is provided with a plurality of gas passages each of which extends from the flat portion toward the membrane electrode assembly, and a border line between the flat portion and the concave-convex portion, the border line being disposed along the first-separator inner edge at the outer side of the first-separator inner edge. When a specific line is defined as a line that is away from the border line toward the first-separator inner edge by the height size of the gas passages, the frame-body inner edge is positioned at a side that is more distant from the first manifold hole in a direction parallel to a surface of the frame body than the specific line is.

In the case where the frame-body inner edge protrudes toward the first manifold hole beyond the border line between the flat portion and the concave-convex portion of the first separator, the flat portion and the frame body face each other in the lamination direction. A groove that extends along the frame-body inner edge is formed between the frame body and the flat portion. The inventors have found that a water droplet easily wetly spreads along the groove in the case where the protrusion amount of the frame-body inner edge from the border line is equal to or larger than the height size of the gas passage in the lamination direction. This is because the water droplet moves mainly by capillary pressure. Moreover, when the protrusion amount of the frame-body inner edge from the border line is equal to or larger than the height size of the gas passage, the height of a sidewall of the groove formed by the frame body reaches a sufficient height for the exertion of the capillary pressure. When the capillary pressure is exerted in the groove, the ease of the wet spread of the water droplet becomes equal between the groove and the gas passage. As a result, there is fear that the wet spread of the water droplet along the groove causes all gas passages to be blocked by the water droplet.

Hence, in the above structure, the frame-body inner edge is positioned at the side that is more distant from the first manifold hole than the specific line is. Accordingly, the protrusion amount of the frame-body inner edge from the border line is smaller than the height size of the gas passage. Thereby, even in the case where the groove is formed between the frame body and the flat portion, it is possible to avoid the capillary pressure from being sufficiently exerted in the groove. Accordingly, it is possible to cause the water droplet to wetly spread more easily in the gas passage than in the groove. It is possible to cause the water droplet to move preferentially to the gas passage, and therefore, it is possible to restrain the water droplet from wetly spreading along the groove. It is possible to prevent all gas passages from being blocked by the water droplet.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is an exploded view of a fuel cell 1;

FIG. 2 is an enlarged top view of a first manifold hole M1o;

FIG. 3 is a partial side view of an inner circumferential surface of the first manifold hole M1o;

FIG. 4 is a partial sectional view taken along line IV-IV in FIG. 2;

FIG. 5 is a partial sectional view of a fuel cell 101 in a comparative example;

FIG. 6 is a partial sectional view of the vicinity of the first manifold hole M1o in an embodiment 2; and

FIG. 7 is a partial sectional view of the vicinity of the first manifold hole M1o in an embodiment 3.

### DETAILED DESCRIPTION OF EMBODIMENTS

A frame-body inner edge may be positioned at a side that is more distant from a first manifold hole in a direction parallel to a surface of a frame body than a border line is.

In the above configuration, the frame-body inner edge does not protrude beyond the border line, and therefore, a groove is not formed between the frame body and a flat portion. Accordingly, it is possible to prevent a water droplet from wetly spreading along the groove.

A second separator may include a second-separator inner edge that demarcates the first manifold hole. The second-separator inner edge may be positioned at a side that is more distant from the first manifold hole in a direction parallel to a surface of the second separator than the border line is.

In the above configuration, the second separator does not face a flat portion of a first separator in a lamination direction. Consequently, the groove is not formed between the second separator and the flat portion. Accordingly, it is possible to prevent the water droplet from wetly spreading along the groove.

The first manifold hole may be an exhaust hole through which a reactive gas introduced into a membrane electrode assembly is exhausted.

The amount of the water droplet is larger in the exhaust hole for the reactive gas than in an introduction hole for the reactive gas. This is because the water droplet after the reaction is included. In the above configuration, it is possible to decrease the amount of the remaining water droplet in the exhaust hole in which a larger amount of water droplet is generated. It is possible to more effectively restrain the gas passage from being blocked due to the freeze of the water droplet.

The contact angle of water on the first separator and the second separator may be smaller than the contact angle of water on the frame body.

In the above configuration, inner wall surfaces of the first and second separators can be higher in hydrophilicity than an inner wall surface of the frame body.

### Embodiment 1

### Schematic Configuration of Fuel Cell 1

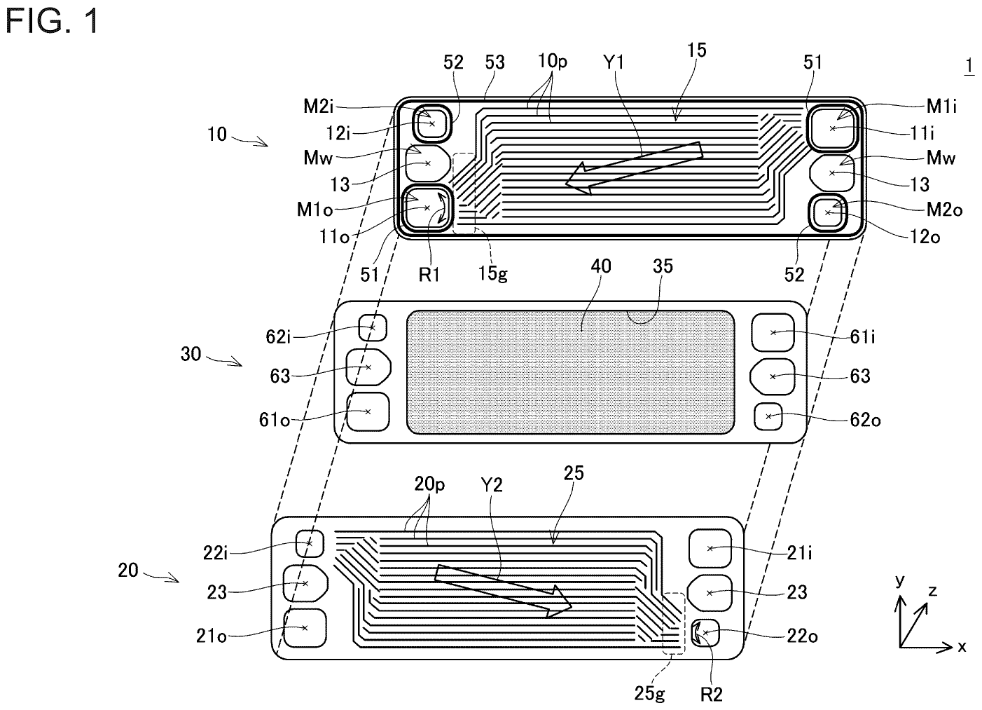

FIG. 1 is an explanatory diagram showing an exploded state of a fuel cell 1 in an embodiment of the present disclosure. The fuel cell 1 is a polymer electrolyte fuel cell that generates electricity by receiving the supply of hydrogen and oxygen. The fuel cell 1 mainly includes a first separator 10, a second separator 20, a frame body 30, and a membrane electrode assembly 40.

The frame body 30 is a frame-shaped resin member that encloses the whole range of the circumference of the membrane electrode assembly 40. As the resin member, in the embodiment, for example, polyethylene naphthalate (PEN) is used. However, as the resin member, various other resin members such as polypropylene, polyethylene, polyethylene terephthalate, and polyphenylene sulfide, and rubber materials can be used.

The frame body 30 includes, at a central portion, an opening portion 35 that encloses and contains the membrane electrode assembly 40. The membrane electrode assembly 40 is disposed in the opening portion 35. In FIG. 1, the membrane electrode assembly 40 is shown as a gray solid portion. Further, the structure of the membrane electrode assembly 40 will be described later. Further, the frame body 30 includes manifold holes 61i, 61o, 62i, 62o, 63, at right and left sides (±x-directional sides) of the opening portion 35.

The first separator 10 and the second separator 20 face each other through the frame body 30 and the membrane electrode assembly 40. The first separator 10 and the second separator 20 have electrical conductivity. For example, the first separator 10 and the second separator 20 may be formed by the press molding of a metal plate composed of stainless steel, titanium, or an alloy of them, or may be formed of a carbon-resin composite material or the like. In the embodiment, the first separator 10 and the second separator 20 are formed of the carbon-resin composite material.

In the embodiment, the first separator 10 is a separator on the cathode side, and the second separator 20 is a separator on the anode side. The first separator 10 includes manifold holes 11i, 11o, 12i, 12o, 13 at an outer edge region thereof. The second separator 20 includes manifold holes 21i, 21o, 22i, 22o, 23 at an outer edge region thereof.

The manifold holes 11i, 61i, 21i are laminated on each other, and thereby, a first manifold hole M1i that is used for the supply of a reaction gas (air) is formed. The manifold holes 11o, 61o, 21o are laminated on each other, and thereby, a first manifold hole M1o that is used for the exhaust of the reaction gas (air) is formed. The manifold holes 12i, 62i, 22i are laminated on each other, and thereby, a second manifold hole M2i that is used for the supply of a reaction gas (hydrogen) is formed. The manifold holes 12o, 62o, 22o are laminated on each other, and thereby, a second manifold hole M2o that is used for the exhaust of the reaction gas (hydrogen) is formed. The manifold holes 13, 63, 23 are laminated on each other, and thereby, a coolant manifold hole Mw that forms a coolant passage is formed. The specific configuration of the coolant passage has no direct relation with the spirit of the technology in the present specification, and therefore, detailed descriptions are omitted. The first manifold holes M1i, M1o, the second manifold holes M2i, M2o, and the coolant manifold hole Mw extend along a lamination direction (z-direction).

The first separator 10 includes a flow passage 15 that extends from the first manifold hole M1i to the first manifold hole M1o. The flow passage 15 is formed by concave-convex portions 10p on a lower surface (that is, a surface that faces the frame body 30) of the first separator 10. The content of the concave-convex portion 10p will be described later. The reaction gas (air) having flowed into the first manifold hole M1i passes through the membrane electrode assembly 40 via the flow passage 15, and is exhausted from the first manifold hole M1o (see an arrow Y1 in FIG. 1).

Similarly, the second separator 20 includes a flow passage 25 that extends from the second manifold hole M2i to the second manifold hole M2o. The flow passage 25 is formed by concave-convex portions 20p on an upper surface (that is, a surface that faces the frame body 30) of the second separator 20. The reaction gas (hydrogen) having flowed into the second manifold hold M2i passes through the membrane electrode assembly 40 via the flow passage 25, and is exhausted from the second manifold hole M2o (see an arrow Y2 in FIG. 1).

Further, gaskets 51, 52, 53 are disposed on an upper surface of the first separator 10. For example, the gaskets 51, 52, 53 are formed of silicone rubber. The gaskets 51 are disposed so as to enclose the manifold holes 11i, 11o respectively. When a plurality of fuel cells 1 is laminated, the sealing property of the first manifold holes M1i, M1o is secured by the gaskets 51. Similarly, the gaskets 52 are disposed so as to enclose the manifold holes 12i, 12o respectively. When a plurality of fuel cells 1 is laminated, the sealing property of the second manifold holes M2i, M2o is secured by the gaskets 52. Further, the gasket 53 is disposed so as to enclose the outer circumference of the first separator 10.

### Structure of First Manifold Hole M1o

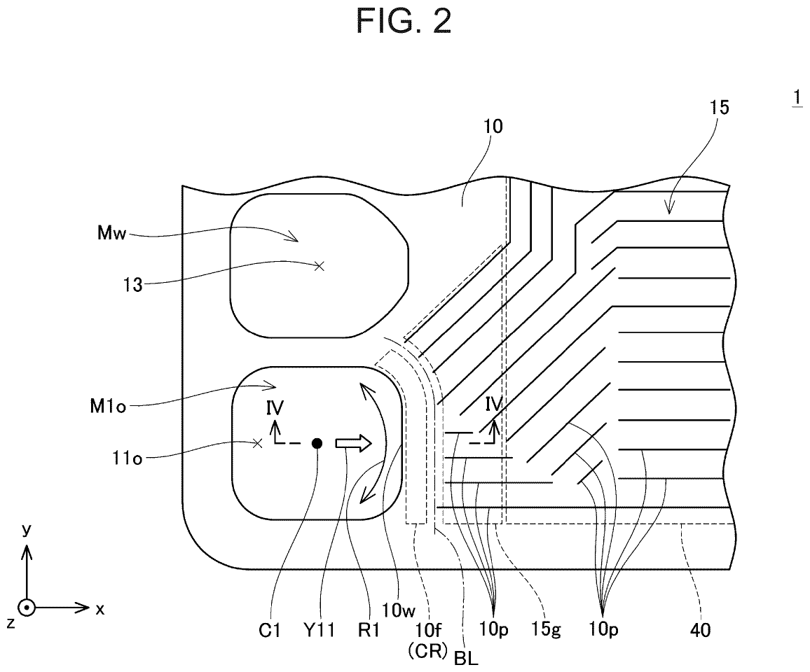

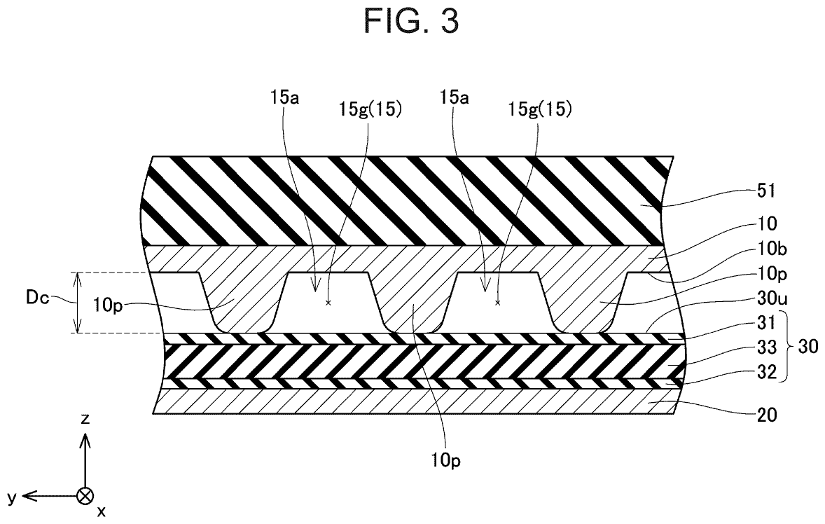

FIG. 2 shows an enlarged top view of the first manifold hole M1o in the fuel cell 1. The first manifold hole M1o is a manifold hole for air exhaust that is disposed at a left lower portion in the fuel cell 1 in FIG. 1. Further, FIG. 3 shows a partial side view of an inner circumferential surface of the first manifold hole M1o as viewed from the direction of an arrow Y11 in FIG. 2. Although FIG. 3 is a side view, hatching is used for clearly showing opening portions 15a.

The flow passage 15 includes a plurality of first gas passages 15g. As shown in FIG. 3, the first gas passages 15g are formed between the frame body 30 and the first separator 10. That is, the concave-convex portions 10p are disposed on a lower surface 10b of the first separator 10, so as to be arrayed in a y-direction. Lower surfaces of the concave-convex portions 10p contact with an upper surface of the frame body 30, and thereby, a first gas passage 15g is formed between adjacent concave-convex portions 10p. Accordingly, in the first gas passage 15g, sidewalls are formed by the concave-convex portions 10p, an inner wall on the upper side is formed by the lower surface 10b of the first separator 10, and an inner wall on the lower side is formed by an upper surface 30u of the frame body 30. The first gas passage 15g has a gas passage height Dc in the z-direction. The gas passage height Dc is the distance between the lower surface 10b of the first separator 10 and the upper surface 30u of the frame body 30.

As shown in FIG. 2, the first gas passages 15g extend from the first manifold hole M1o to the membrane electrode assembly 40. Further, terminal opening portions of the first gas passages 15g are disposed in a first region R1 on the inner circumferential surface of the first manifold hole M1o. Accordingly, as shown in FIG. 3, in the first region R1, opening portions 15a of the first gas passages 15g appear on the inner circumferential surface of the first manifold hole M1o.

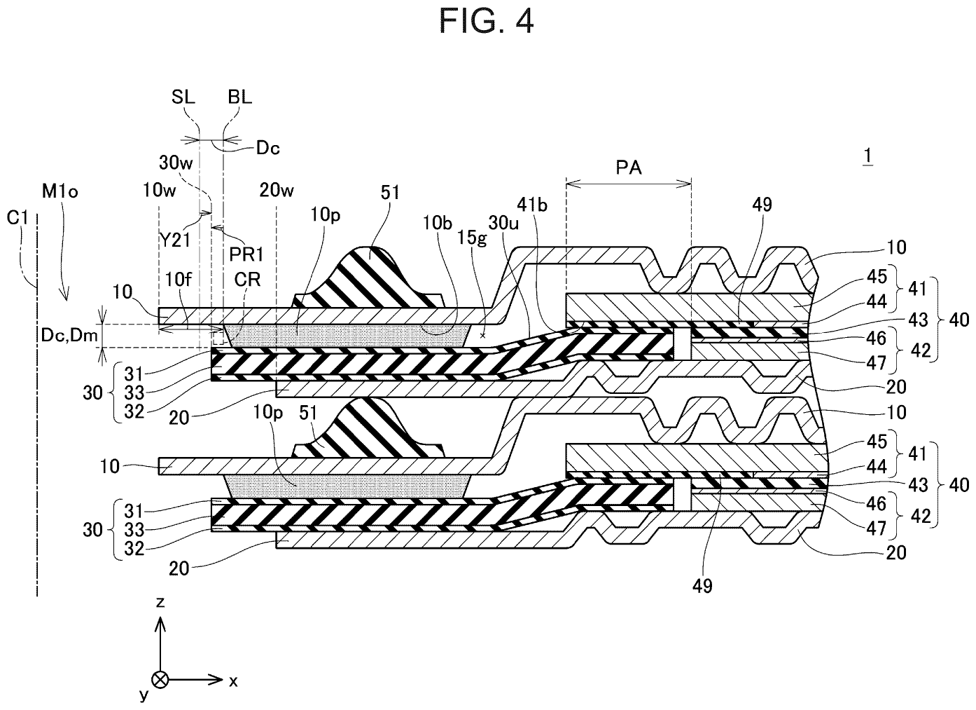

FIG. 4 shows a partial sectional view taken along line IV-IV in FIG. 2. FIG. 4 is a sectional view that passes through a central axis C1 of the first manifold hole M1o and that passes through first gas passages 15g. FIG. 4 shows a fuel cell stack in which two fuel cells 1 are laminated. In an actual fuel cell stack, three or more fuel cells 1 are laminated. The membrane electrode assembly 40 includes an oxygen electrode 41, a hydrogen electrode 42, and an electrolyte membrane 43. The electrolyte membrane 43 is an ion-exchange membrane that is formed of a solid polymer material and that has proton conductivity. The oxygen electrode 41 includes a first catalyst layer 44 and a first gas diffusion layer 45. The hydrogen electrode 42 includes a second catalyst layer 46 and a second gas diffusion layer 47. Each of the first catalyst layer 44 and the second catalyst layer 46 is a porous layer in which carbon particles or metal oxides supporting a catalyst are coupled by resin. Each of the first gas diffusion layer 45 and the second gas diffusion layer 47 is an electrically conductive member that has water permeability and gas permeability. For the membrane electrode assembly 40, a well-known structure can be applied, and therefore, detailed descriptions are omitted.

At the outer circumference of the membrane electrode assembly 40, an outer circumferential region PA having a flange shape is formed by the oxygen electrode 41. In the outer circumferential region PA, an adhesion layer 49 is disposed on a lower surface 41b of the oxygen electrode 41. The adhesion layer 49 is a layer that is formed by an adhesive agent. Examples of the adhesive agent include an ultraviolet curable adhesive agent and a hot-melt adhesive agent. By the adhesion layer 49, the lower surface 41b of the oxygen electrode 41 is fixed to the upper surface 30u of the frame body 30.

The frame body 30 has a three-layer structure in which a first resin layer 31, a core layer 33, and a second resin layer 32 are laminated in a thickness direction. The core layer 33 is a structural member that has gas seal property and insulation property. The first resin layer 31 is a layer that adheres to the first separator 10. The second resin layer 32 is a layer that adheres to the second separator 20.

Each of the first resin layer 31 and the second resin layer 32 may have a lower melting point than the core layer 33. Specifically, each of the first resin layer 31 and the second resin layer 32 may be composed of a thermoplastic resin such as an acid-modified olefin resin and a polyester resin. The frame body 30 having a multi-layer structure can be formed by various methods. For example, the frame body 30 may be formed by coextrusion molding.

The frame body 30 includes a frame-body inner edge 30w. The frame-body inner edge 30w is a site that constitutes a part of the inner wall of the first manifold hole M1o, and demarcates the first manifold hole M1o.

The first separator 10 includes a first-separator inner edge 10w, the concave-convex portions 10p, a flat portion 10f, and a border line BL. The first-separator inner edge 10w is a site that constitutes a part of the inner wall of the first manifold hole M1o, and demarcates the first manifold hole M1o. The concave-convex portion 10p is a site that protrudes downward from the lower surface 10b of the first separator 10. In the sectional view in FIG. 4, for clear illustration, a concave-convex portion 10p that exists in a depth direction with respect to the sheet plane is shown as a gray solid portion. Further, as shown in FIG. 2, the first gas passages 15g that extend from the flat portion 10f toward the membrane electrode assembly 40 are formed by the concave-convex portions 10p.

The flat portion 10f is a region at the vicinity of the first-separator inner edge 10w, and is a region where the concave-convex portion 10p is not disposed. Further, the flat portion 10f is disposed on a facing surface (that is, the lower surface 10b) that faces the second separator 20. As shown in FIG. 2, the flat portion 10f is disposed along the first-separator inner edge 10w. The flat portion 10f serves also as a site that is necessary for the punching process of the manifold hole 11o. A cut surface is constituted by the flat portion 10f, and therefore, the precision and processability of the cut surface can be enhanced.

The border line BL is formed between the flat portion 10f and the concave-convex portion 10p. As shown in FIG. 2, the border line BL is disposed along the first-separator inner edge 10w at the outer side of the first-separator inner edge 10w. The first gas passage 15g is formed at a side (+x-directional side) that is more distant from the first manifold hole M1o than the border line BL is. On the other hand, a groove region CR is formed at a side (−x-directional side) that is closer to the first manifold hole M1o than the border line BL is.

As shown in FIG. 4, the groove region CR is a region that is formed between the flat portion 10f and a surface (that is, the upper surface 30u of the frame body 30) that faces the flat portion 10f. The groove region CR has a groove region height Dm in the z-direction. The groove region height Dm is equal to the gas passage height Dc.

Further, as shown in FIG. 2, the groove region CR is disposed along the first-separator inner edge 10w. That is, the groove region CR functions as a region that connects the first gas passages 15g together along the first-separator inner edge 10w.

As shown in FIG. 4, a specific line SL is defined. The specific line SL is a line that is away in parallel from the border line BL to the first-separator inner edge 10w side (−x-directional side) by the gas passage height Dc. Moreover, the frame-body inner edge 30w is positioned at a side (+x-directional side) that is more distant from the first manifold hole M1o than the specific line SL is (see an arow Y21).

The second separator 20 includes a second-separator inner edge 20w. The second-separator inner edge 20w is a site that constitutes a part of the inner wall of the first manifold hole M1o, and demarcates the first manifold hole M1o. The second-separator inner edge 20w is positioned at a side (+x-directional side) that is more distant from the first manifold hole M1o than the border line BL is.

The contact angle of water on the first separator 10 and the second separator 20 is smaller than the contact angle of water on the frame body 30. For example, the contact angle of water on the first separator 10 and the second separator 20 may be smaller than 90°, and the contact angle of water on the frame body 30 may be larger than 90°. That is, the first-separator inner edge 10w and the second-separator inner edge 20w are higher in hydrophilicity than the frame-body inner edge 30w. This is because the frame body 30 has water repellency due to a property inherent in the above-described resin member. Further, this is because the first separator 10 and the second separator 20 have hydrophilicity due to a property inherent in the above-described electrically conductive material. Herein, the hydrophilicity is the hydrophilicity under an environment of the electricity generation of the fuel cell (under an environment in which a water droplet exists in a high-temperature and high-humidity condition).

### Problem

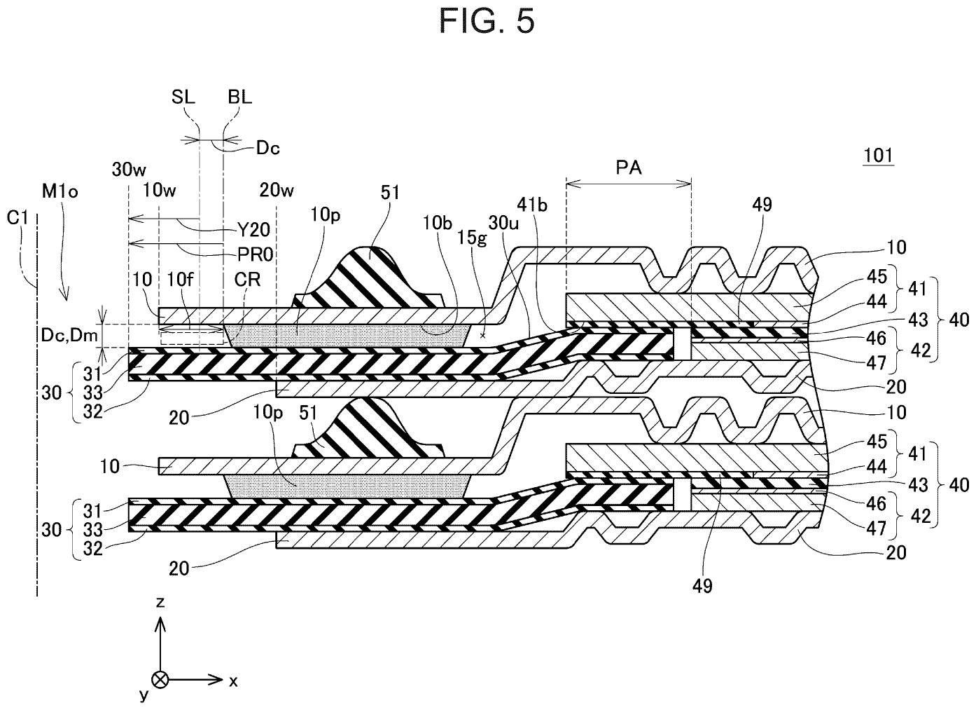

A problem will be described with use of a fuel cell 101 in a comparative example in FIG. 5. The fuel cell 101 (FIG. 5) in the comparative example is different from the fuel cell 1 (FIG. 4) in the embodiment, in the position relation of the frame-body inner edge 30w. Specifically, the frame-body inner edge 30w is positioned at a side (−x-directional side) that is closer to the first manifold hole M1o than the specific line SL is (see an arrow Y20). That is, a protrusion amount PR0 of the frame-body inner edge 30w from the border line BL is equal to or more than the gas passage height Dc. The other structures of the fuel cell 101 in the comparative example are the same as those of the fuel cell 1 in the embodiment, and therefore, descriptions are omitted.

In the fuel cell 101 in the comparative example, the groove region CR is formed between the upper surface 30u of the frame body 30 and the flat portion 10f of the first separator 10. As shown in FIG. 2, the groove region CR connects the first gas passages 15g together along the first-separator inner edge 10w. Thus, the water droplet remaining on the inner circumferential surface of the first manifold hole M1o wetly spreads along the groove region CR, in some cases. When the water droplet spreads over the whole range of the first region R1, all first gas passages 15g are covered with the water droplet. In this state, when the water droplet freezes, all first gas passages 15g are blocked. As a result, at the time of start, the intake and exhaust of reaction gases cannot be performed for the membrane electrode assembly and electricity generation cannot be performed, in some cases.

### Solution and Effect

The inventors have found that the water droplet easily wetly spreads along the groove region CR in the case where the protrusion amount of the frame-body inner edge 30w from the border line BL is equal to or larger than the gas passage height Dc of the first gas passage 15g. This is because the water droplet moves mainly by capillary pressure. Moreover, when the protrusion amount of the frame-body inner edge 30w from the border line BL is equal to or larger than the gas passage height Dc, the x-directional height of the sidewall of the groove region CR formed by the upper surface 30u of the frame-body inner edge 30w reaches a sufficient height for the exertion of the capillary pressure. When the capillary pressure is sufficiently exerted in the groove region CR, the ease of the wet spread of the water droplet becomes equal between the groove region CR and the first gas passage 15g. As a result, there is fear that the wet spread of the water droplet along the groove region CR causes all first gas passages 15g to be blocked by the water droplet.

Hence, in the technology of the embodiment, the frame-body inner edge 30w is positioned at the +x-directional side of the specific line SL (see FIG. 4). That is, in the embodiment, a protrusion amount PR1 of the frame-body inner edge 30w from the border line BL is smaller than the gas passage height Dc. Accordingly, the x-directional height of the sidewall of the groove region CR does not reach the sufficient height for the exertion of the capillary pressure. Thereby, it is possible to cause the water droplet to wetly spread more easily in the first gas passage 15g than in the groove region CR. It is possible to cause the water droplet to move preferentially to the first gas passage 15g, and therefore, it is possible to restrain the water droplet from wetly spreading along the groove region CR. It is possible to prevent all first gas passages 15g from being blocked by the water droplet.

The fuel cell 1 (FIG. 4) in the embodiment has a structure in which the first-separator inner edge 10w protrudes to the central axis C1 side relative to the frame-body inner edge 30w. Thereby, in the first region R1 (the region where the opening portion 15a of the first gas passage 15g is disposed), a relatively hydrophilic member can be exposed on the inner circumferential surface of the first manifold hole M1o. The hydrophilicity can facilitate the mutual joining of water droplets on the inner circumferential surface of the first manifold hole M1o, in the first region R1. The volume of the water droplet increases, and therefore, the water droplet can be easily exhausted by gravity and gas flow. It is possible to decrease the amount of the water droplet remaining on the inner circumferential surface of the first manifold hole M1o, and therefore, it is possible to restrain the first gas passages 15g from being blocked due to the freeze of the water droplet. It is possible to improve the startability of the fuel cell 1 below the freezing point.

The amount of the water droplet is larger in the first manifold hole M1o that is the exhaust hole for the reactive gas, than in the first manifold hole M1i that is the introduction hole for the reactive gas. This is because the water droplet after the reaction is included. In the fuel cell 1 in the embodiment, the hydrophilic member (first-separator inner edge 10w) protrudes from the inner circumferential surface of the first manifold hole M1o on the exhaust side. Thereby, the effect of the decrease in the amount of the remaining water droplet can be obtained on the inner circumferential surface of the first manifold hole M1o on the exhaust side where a larger amount of water droplet is generated. Therefore, it is possible to restrain the first gas passages 15g from being blocked.

### Modification of Embodiment 1

The above-described structure of the first manifold hole M1o on the exhaust side can be applied also to the first manifold hole M1i on the introduction side. That is, it is allowable to have a structure in which the frame-body inner edge 30w is positioned at a side that is more distant from the first manifold hole M1i than the specific line SL is. Similarly, the structures of the first manifold holes M1o, M1i for air can be applied also to the second manifold holes M2o, M2i for hydrogen.

The structure in which the frame-body inner edge 30w is positioned at the side that is more distant from the first manifold hole M1o than the specific line SL is does not need to be formed over the whole of the inner circumferential surface of the first manifold hole M1o, and only needs to be formed at least in the first region R1 (FIG. 2). Regions other than the first region R1 are regions that are distant from the first gas passages 15g. Even when the water droplet wetly spreads to the distant regions, there is little fear that the first gas passages 15g are blocked.

The structure in which the frame-body inner edge 30w is positioned at the side that is more distant from the first manifold hole M1o than the specific line SL is does not need to be formed over the whole region of the first region R1 (FIG. 2), and only needs to be formed at least in a partial region. Thereby, it is possible to prevent all first gas passages 15g from being blocked due to the freeze of the water droplet. Since at least some of the first gas passages 15g are opened, the fuel cell 1 can be started.

### Embodiment 2

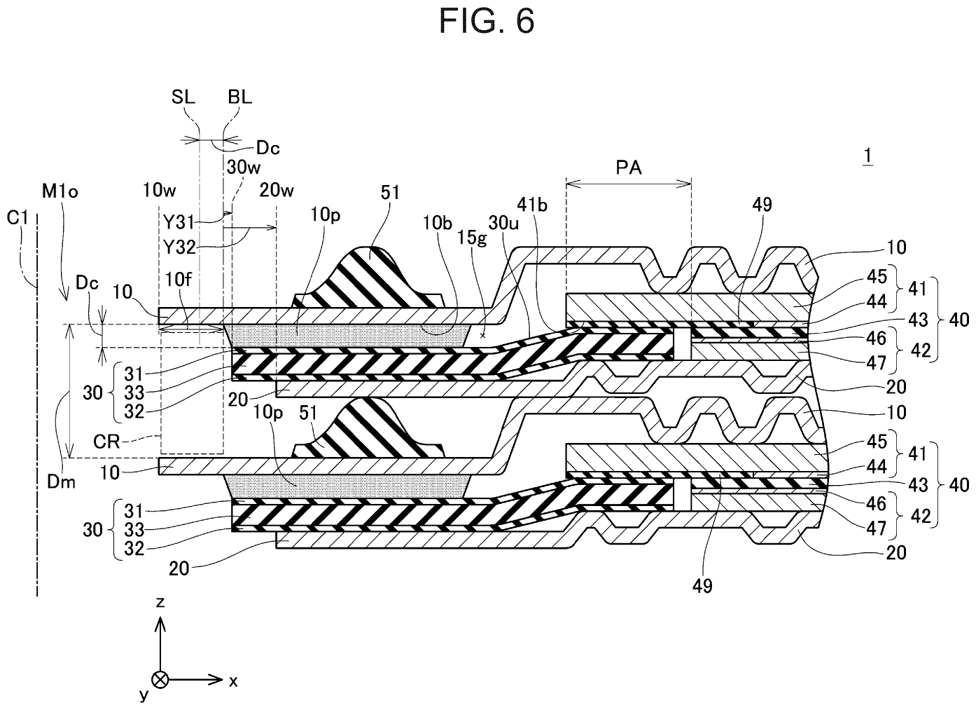

An embodiment 2 (FIG. 6) is different from the embodiment 1 (FIG. 4) in the position relation of the frame-body inner edge 30w. Specifically, the frame-body inner edge 30w is positioned at a side (+x-directional side) that is more distant from the first manifold hole M1o than the border line BL is (see an arrow Y31). The other structures in the embodiment 2 are the same as those in the embodiment 1. Descriptions of common portions between the embodiment 1 and the embodiment 2 are omitted.

The second-separator inner edge 20w is positioned at a side (+x-directional side) that is more distant from the first manifold hole M1o than the border line BL is (see an arrow Y32). That is, in the fuel cell 1 in the embodiment 2, the frame-body inner edge 30w and the second-separator inner edge 20w are disposed at the back side (+x-directional side) of the flat portion 10f of the first separator 10. Accordingly, the surface that faces the flat portion 10f is the first separator 10 of the adjacent fuel cell 1. Thereby, the groove region height Dm of the groove region CR is equal to the cell pitch between the fuel cells 1. That is, it is possible to maximize the groove region height Dm.

### Effect

In the technology in the embodiment 2, by the maximization of the groove region height Dm, it is possible to minimize the capillary pressure that is generated in the groove region CR. This is because the capillary pressure is generally lower as the width (that is, the groove region height Dm) of the groove serving as the flow passage is larger. Thereby, it is possible to cause the water droplet to wetly spread more easily in the first gas passage 15g than in the groove region CR. It is possible to cause the water droplet to move preferentially to the first gas passage 15g, and therefore, it is possible to restrain the water droplet from wetly spreading along the groove region CR.

### Embodiment 3

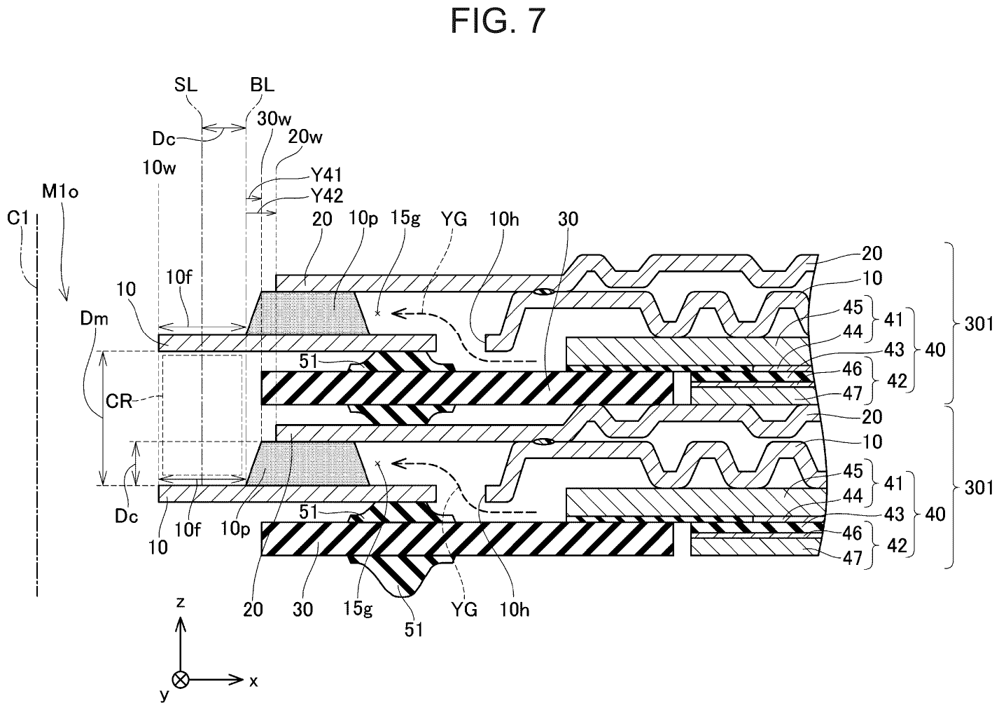

A fuel cell 301 (FIG. 7) in an embodiment 3 is different from the fuel cell 1 in the embodiment 1 (FIG. 4), in the arrangement manner in the single cell. Specifically, the second separator 20 is exposed on an upper surface at the +z-directional side of the fuel cell 301, and the membrane electrode assembly 40 is exposed on a lower surface at the −z-directional side. Common sites between the embodiment 1 (FIG. 4) and the embodiment 3 (FIG. 7) are denoted by identical reference characters, and descriptions thereof are omitted.

The first gas passage 15g of the fuel cell 301 is formed between the first separator 10 and the second separator 20 that face each other. The first gas passage 15g has a gas passage height Dc in the z-direction. The first gas passage 15g communicates with the membrane electrode assembly 40 through a communication hole 10h. The gas exhausted from the oxygen electrode 41 passes through the communication hole 10h, and is exhausted to the first gas passage 15g (see a dotted-line arrow YG).

The frame-body inner edge 30w is positioned at a side (+x-directional side) that is more distant from the first manifold hole M1o than the border line BL is (see an arrow Y41). Further, the second-separator inner edge 20w is positioned at a side (+x-directional side) that is more distant from the first manifold hole M1o than the border line BL is (see an arrow Y42). Accordingly, the surface that faces the flat portion 10f is the first separator 10 of the adjacent fuel cell 301. Thereby, the groove region height Dm of the groove region CR is equal to the cell pitch between the fuel cells 301. By the maximization of the groove region height Dm, it is possible to minimize the capillary pressure that is generated in the groove region CR. It is possible to restrain the water droplet from wetly spreading along the groove region CR.

The embodiments have been described above. The embodiments are just examples, and do not limit the scope of the claims. The technology described in the claims includes various modifications and alterations of the above-described specific examples. Technical elements described in the present specification or the drawings exert technical utility independently or by various combinations, and are not limited to combinations described in the claims at the time of the filing. Further, technologies exemplified in the present specification or the drawings concurrently achieve a plurality of purposes, and have technical utility simply by achieving one of the purposes.

### Modification

The technology in the present specification can be applied to both of an air-cooled fuel cell and a water-cooled fuel cell.

In the embodiments, in the figures, each shape of the first manifold holes M1i, M1o, the second manifold holes M2i, M2o, and the coolant manifold hole Mw is a rectangular shape. However, manifold holes having a triangular shape, a polygonal shape, or different opening shapes may be adopted.

What is claimed is:

1. A fuel cell stack in which a plurality of fuel cells is laminated, wherein:
each of the fuel cells includes
a frame body that is made of resin and that includes an opening portion,
a membrane electrode assembly that is disposed at the opening portion, and
a first separator and a second separator that face each other through the frame body and the membrane electrode assembly;
a first manifold hole that extends along a lamination direction is provided in the fuel cell stack;
the frame body includes a frame-body inner edge that demarcates the first manifold hole;
the first separator includes
a first-separator inner edge that demarcates the first manifold hole,
a flat portion that is disposed along the first-separator inner edge and that is disposed on a facing surface that faces the second separator,
a concave-convex portion that is provided with a plurality of gas passages each of which extends from the flat portion toward the membrane electrode assembly, and
a border line between the flat portion and the concave-convex portion, the border line being disposed along the first-separator inner edge at an outer side of the first-separator inner edge; and
when a specific line is defined as a line that is away from the border line toward the first-separator inner edge by a height size of the gas passages, the frame-body inner edge is positioned at a side that is more distant from the first manifold hole in a direction parallel to a surface of the frame body than the specific line is.

2. The fuel cell stack according to claim 1, wherein the frame-body inner edge is positioned at a side that is more distant from the first manifold hole in the direction parallel to the surface of the frame body than the border line is.

3. The fuel cell stack according to claim 1, wherein:
the second separator includes a second-separator inner edge that demarcates the first manifold hole; and
the second-separator inner edge is positioned at a side that is more distant from the first manifold hole in a direction parallel to a surface of the second separator than the border line is.

4. The fuel cell stack according to claim 1, wherein the first manifold hole is an exhaust hole through which a reactive gas introduced into the membrane electrode assembly is exhausted.

5. The fuel cell stack according to claim 1, wherein a contact angle of water on the first separator and the second separator is smaller than a contact angle of water on the frame body.
